(19) United States
(12) Patent Application Publication
(10) Pub. No.: US 2019/0014641 A1
(43) Pub. Date: Jan. 10, 2019

(54) ELECTRONIC CANDLE

(71) Applicants: Junjie Feng, Thousand Oaks, CA (US); Jianliang Feng, Enping (CN)

(72) Inventors: Junjie Feng, Thousand Oaks, CA (US); Jianliang Feng, Enping (CN)

(21) Appl. No.: 16/032,030

(22) Filed: Jul. 10, 2018

Related U.S. Application Data
(60) Provisional application No. 62/530,789, filed on Jul. 10, 2017.

(51) Int. Cl. H05B 37/02; F21V 23/04; H05B 33/08; F21S 10/04; F21S 6/00

(52) U.S. Cl. CPC H05B 37/0227; F21V 23/0485; F21W 2121/00; F21S 10/046; F21S 6/001; H05B 33/0854

(57) ABSTRACT

An electronic candle may include a main candle body, a signal processing module, a candle flame piece, a lighting unit to light up the candle flame piece and an air flow detecting unit, wherein the candle flame piece extends from a through hole from an inner portion of the main candle body to an outer portion thereof, and edges of the candle flame piece axially shrinks towards a center portion of the candle flame piece; the lighting unit is disposed below the candle flame piece to light up the candle flame piece; the air flow detecting unit is disposed at an inner portion of the electronic candle, and the air flow detecting unit and the lighting unit are both connected to the signal processing module.

### CROSS-REFERENCE TO RELATED APPLICATIONS

This application claims priority under 35 U.S.C. § 119 (e) to U.S. Provisional Patent Application Ser. No. 62/530,789, filed on Jul. 10, 2017, the entire contents of which are hereby incorporated by reference.

### FIELD OF THE INVENTION

The present invention relates to an electronic candle, and more particularly to an electronic candle that the flame thereof can be easily put out when the user blows air to it.

### BACKGROUND OF THE INVENTION

Currently, most electronic candles can simulate real candle flame, and the flame can be put out when the user blows air to it. However, the piece to simulate candle flame in current electronic candles is cylindrical and is located axially from an inner portion of the electronic candle from an outer portion thereof, so the air blown by the user is blocked by the candle flame piece and cannot get into the inner portion of the electronic candle. Thus, the user has to spend more effort to blow the air to put out the candle flame. Therefore, there remains a need for a new and improved electronic candle to overcome the problems stated above.

### SUMMARY OF THE INVENTION

In one aspect, an electronic candle may include a main candle body, a signal processing module, a candle flame piece, a lighting unit to light up the candle flame piece and an air flow detecting unit. The electronic candle may further include a through hole for the candle flame piece to extend from an inner portion of the main candle body to an outer portion thereof, and the edges of the candle flame piece axially shrinks towards a center portion of the candle flame piece. The lighting unit is disposed below the candle flame piece to light up the candle flame piece, the air flow detecting unit is disposed at an inner portion of the electronic candle, and the air flow detecting unit and the lighting unit are both connected to the signal processing module. In one embodiment, the lighting unit is an LED lighting unit. In another embodiment, the air flow detecting unit is a sound receiving and detecting unit, such as a high sensitivity telephone transmitter. When the air blown by the user flows into the inner portion of the main candle body, it may generate some sound that can be caught by the air flow detecting unit to transmit a signal to the signal processing module to shut the lighting unit, namely putting out the candle flame. It is noted that since the edges of the candle flame piece shrinks towards the center portion of the candle flame piece at the through hole, it creates more space for the air to be more effectively flowing into the main candle body to increase the accuracy for the air flow detecting unit.

More specifically, when the user blows the air to the candle flame piece, the air flows into the main candle body from the edges of the candle flame piece and the gap between the candle flame piece and through hole. When the air flow detecting unit detects the sound of air flow, a signal will be sent to the signal processing module from the air flow detecting unit, and when the signal processing module receives the signal from the air flow detecting unit, the signal processing module turns off the lighting unit so the flame of the electronic candle is then put out when the user blows air to it.

Conventionally, the candle flame piece is cylindrical to narrow the gap between the candle flame piece and the through hole, so most air flow is blocked by the candle flame piece and fewer air flows into the inner portion of the electronic candle, and the user has to spend more efforts to put out the flame of the electronic candle or cannot even put it out. The present invention is advantageous because the edges of the candle flame piece shrinks towards the center portion of the candle flame piece at the through hole, it creates more space for the air to be more effectively flowing into the main candle body to increase the accuracy for the air flow detecting unit, so the flame can be easily put out when the user blows the air into the electronic candle.

In another aspect, the center line of the candle flame piece is away from a center line of the through hole and is disposed closer to the air flow detecting unit. A sleeve is disposed around the through hole to increase the incoming air flow. The edges of the candle flame piece shrink toward the center portion of the candle flame piece and are disposed at substantially the same height of the sleeve. Because of the arrangement between the candle flame piece and the through hole and the effect of the sleeve to the incoming air flow, the air can be more easily directed and flew into the inner portion of the main candle body. The protruding sleeve is configured to block the air flow to move forward and to force the air flow to move down along the inner portion of the sleeve to the inner portion of the main candle body to increase the air flow thereto, which further increases the accuracy of the air flow detecting unit so the user does not have to spend much effort to blow the air into the candle to put out the candle flame.

In one embodiment, the sleeve has a movable rack to enhance the movement of the candle flame piece. A magnet is attached to a bottom portion of the candle flame piece and the signal processing module controls an electromagnetic switch module to attract the magnet with a periodic magnetic force to drive the candle flame piece to move. With the periodic electromagnetic attraction to the magnet along with the movement of the movable rack, the candle flame piece resembles the real flame of the candle.

### BRIEF DESCRIPTION OF THE DRAWINGS

FIG. 1 is a schematic view of the electronic candle in the present invention.

FIG. 2 is a top view of the electronic candle in the present invention.

FIG. 3 is a sectional view of FIG. 2 along line A.

FIG. 4 is a schematic view of part C in FIG. 3.

FIG. 5 is a sectional view of FIG. 2 along line B.

FIG. 6 illustrates a schematic view of the candle flame piece and the air flow detecting unit.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

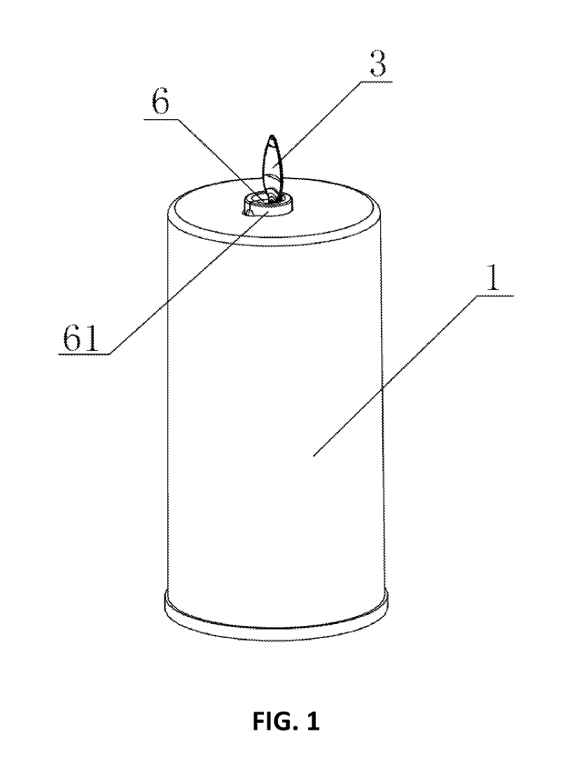

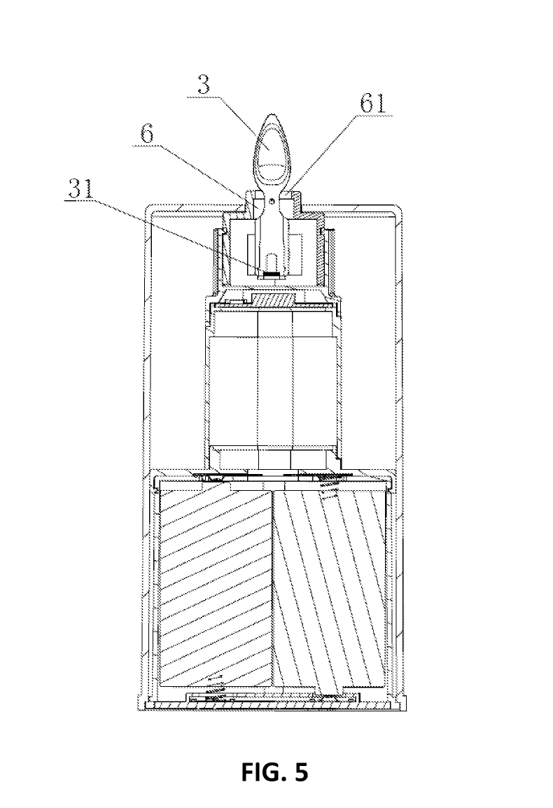

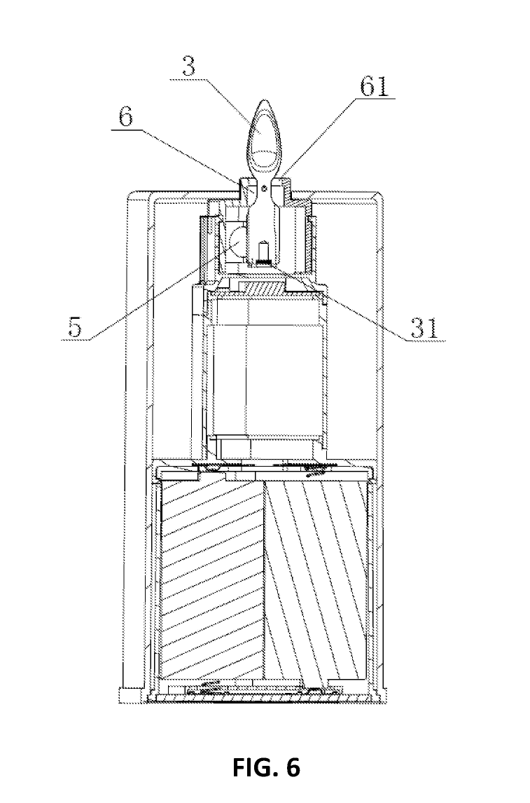

In one aspect, as shown in FIGS. 1 to 6, an electronic candle may include a main candle body 1, a signal processing module 2, a candle flame piece 3, a lighting unit 4 to light up the candle flame piece 3 and an air flow detecting unit 5. The electronic candle may further include a through hole 6 for the candle flame piece 3 to extend from an inner portion of the main candle body 1 to an outer portion thereof, and the edges of the candle flame piece 3 axially shrinks towards a center portion of the candle flame piece 3. The lighting unit 4 is disposed below the candle flame piece 3 to light up the candle flame piece 3, the air flow detecting unit 5 is disposed at an inner portion of the electronic candle, and the air flow detecting unit 5 and the lighting unit 4 are both connected to the signal processing module 2. In one embodiment, the lighting unit 4 is an LED lighting unit. In another embodiment, the air flow detecting unit 5 is a sound receiving and detecting unit, such as a high sensitivity telephone transmitter. When the air blown by the user flows into the inner portion of the main candle body 1, it may generate some sound that can be caught by the air flow detecting unit 5 and a signal is generated and transmitted to the signal processing module 2 to shut the lighting unit, namely putting out the candle flame. It is noted that since the edges of the candle flame piece 3 shrinks towards the center portion of the candle flame piece 3 at the through hole 6, it creates more space for the air to be more effectively flowing into the main candle body 1 to increase the accuracy for the air flow detecting unit 5.

More specifically, when the user blows the air to the candle flame piece 3, the air flows into the main candle body 1 from the edges of the candle flame piece 3 and the gap between the candle flame piece 3 and through hole 6. When the air flow detecting unit 5 detects the sound of air flow, a signal will be sent to the signal processing module 2 from the air flow detecting unit 5, and when the signal processing module 2 receives the signal from the air flow detecting unit 5, the signal processing module 2 turns off the lighting unit 4 so the flame of the electronic candle is then put out when the user blows air to it.

Conventionally, the candle flame piece is cylindrical to narrow the gap between the candle flame piece and the through hole, so most air flow is blocked by the candle flame piece and fewer air flows into the inner portion of the electronic candle, and the user has to spend more efforts to put out the flame of the electronic candle or cannot even put it out. The present invention is advantageous because the edges of the candle flame piece 3 shrinks towards the center portion of the candle flame piece 3 at the through hole 6, it creates more space for the air to be more effectively flowing into the main candle body 1 to increase the accuracy for the air flow detecting unit 5, so the flame can be easily put out when the user blows the air into the electronic candle.

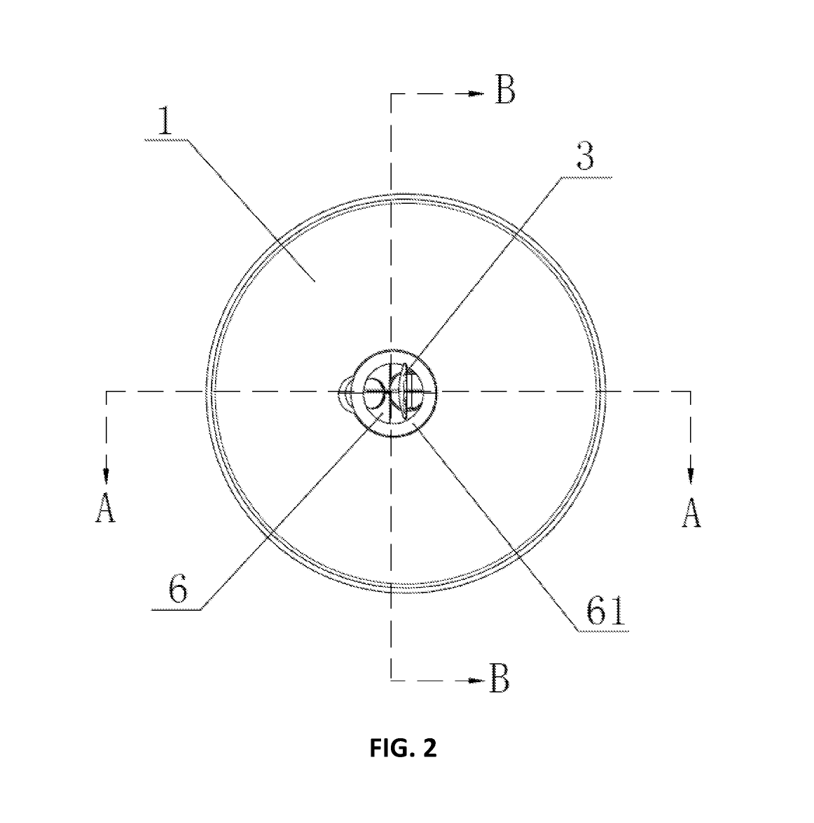

In another aspect, as shown in FIGS. 2 to 6, the center line of the candle flame piece 3 is away from a center line of the through hole 6 and is disposed closer to the air flow detecting unit 5. A sleeve 61 is disposed around the through hole 6 to increase the incoming air flow. The edges of the candle flame piece 3 shrink toward the center portion of the candle flame piece 3 and are disposed at substantially the same height of the sleeve 61. Because of the arrangement between the candle flame piece 3 and the through hole 6 and the effect of the sleeve 61 to the incoming air flow, the air can be more easily directed and flew into the inner portion of the main candle body 1. The protruding sleeve 61 is configured to block the air flow to move forward and to force the air flow to move down along the inner portion of the sleeve 61 to the inner portion of the main candle body 1 to increase the air flow thereto, which further increases the accuracy of the air flow detecting unit 5 so the user does not have to spend much effort to blow the air into the candle to put out the candle flame.

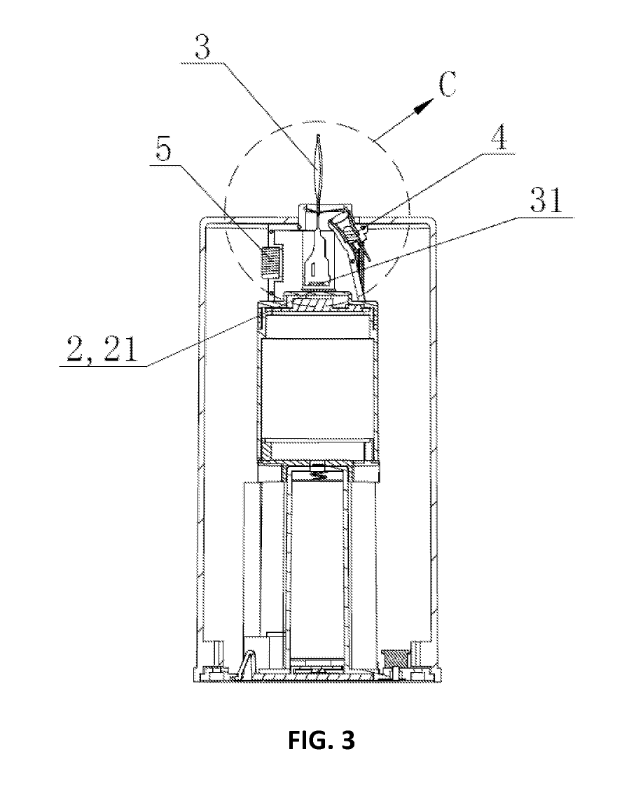

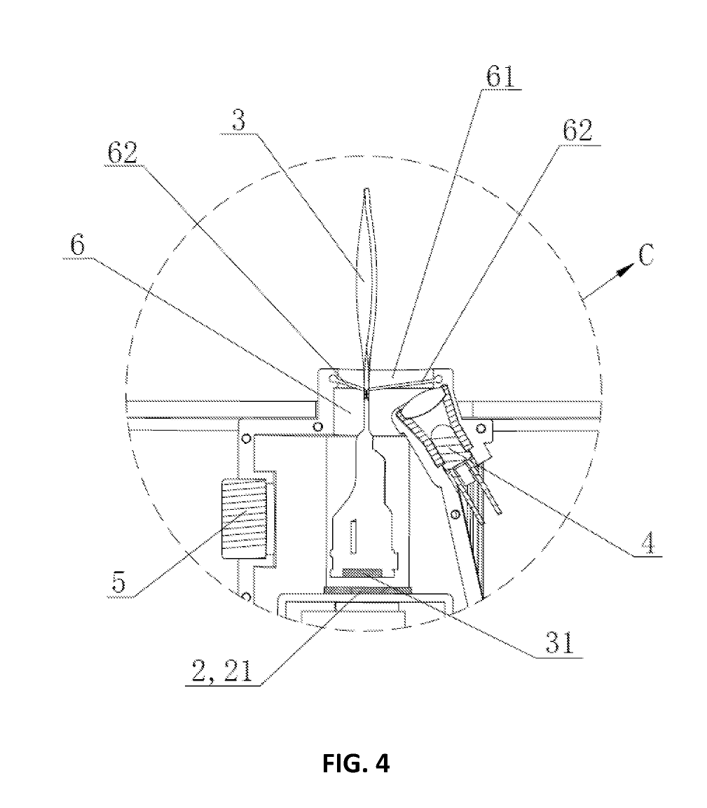

In one embodiment, as shown in FIGS. 3 and 4, the sleeve 61 has a movable rack 62 to enhance the movement of the candle flame piece 3. A magnet 31 is attached to a bottom portion of the candle flame piece 3 and the signal processing module 2 controls an electromagnetic switch module 21 to attract the magnet 31 with a periodic magnetic force to drive the candle flame piece 3 to move. With the periodic electromagnetic attraction to the magnet 31 along with the movement of the movable rack 62, the candle flame piece 3 resembles the real flame of the candle.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An electronic candle comprising a main candle body, a signal processing module, a candle flame piece, a lighting unit to light up the candle flame piece and an air flow detecting unit, wherein the candle flame piece extends from a through hole from an inner portion of the main candle body to an outer portion thereof, and edges of the candle flame piece axially shrinks towards a center portion of the candle flame piece; the lighting unit is disposed below the candle flame piece to light up the candle flame piece; the air flow detecting unit is disposed at an inner portion of the electronic candle, and the air flow detecting unit and the lighting unit are both connected to the signal processing module.

2. The electronic candle of claim 1, wherein a center line of the candle flame piece is positioned away from a center line of the through hole and is disposed closer to the air flow detecting unit.

3. The electronic candle of claim 2, wherein a sleeve is disposed around the through hole to increase the incoming air flow, and the edges of the candle flame piece shrink toward the center portion of the candle flame piece and are disposed at substantially the same height of the sleeve.

4. The electronic candle of claim 3, wherein the sleeve has a movable rack to enhance the movement of the candle flame piece.

5. The electronic candle of claim 4, wherein a magnet is attached to a bottom portion of the candle flame piece and the signal processing module controls an electromagnetic switch module to attract the magnet with a periodic magnetic force to drive the candle flame piece to move.

6. The electronic candle of claim 1, wherein the air flow detecting unit is a sound receiving and detecting unit, and when a sound is generated by the air blown by the user into the inner portion of the main candle body, the air flow detecting unit is configured to detect the sound and transmit a signal processing module to shut the lighting unit, namely putting out the candle flame.

7. The electronic candle of claim 5, wherein the air flow detecting unit is a sound receiving and detecting unit, and when a sound is generated by the air blown by the user into the inner portion of the main candle body, the air flow detecting unit is configured to detect the sound and transmit a signal processing module to shut the lighting unit, namely putting out the candle flame.

8. The electronic candle of claim 1, wherein the lighting unit is an LED lighting unit.
